(19) United States
(12) Patent Application Publication
(10) Pub. No.: US 2011/0246453 A1
(43) Pub. Date: Oct. 6, 2011

(54) Apparatus and Method for Visual Presentation of Search Results to Assist Cognitive Pattern Recognition

(76) Inventors: Basker S. Krishnan, San Marino, CA (US); Hanoz J. Kateli, Monrovia, CA (US); Bryan Heesch, Arcadia, CA (US)

(21) Appl. No.: 12/836,293

(22) Filed: Jul. 14, 2010

Related U.S. Application Data
(60) Provisional application No. 61/321,132, filed on Apr. 6, 2010.

(51) Int. Cl. G06F 17/30

(52) U.S. Cl. 707/722; 707/E17.014

(57) ABSTRACT

An apparatus and method for searching using cognitive pattern recognition comprising searching at least one document associated with a search text; presenting a quantity of the at least one document in a scaled common image format (CIF); selecting a document in the quantity for display; adding a visual distinction to all pages of the selected document where the search text exists from the rest of the pages of the selected document; and displaying all pages of the selected document wherein the search text exists in the scaled common image format (CIF).

### CLAIM OF PRIORITY UNDER 35 U.S.C. §119

The present Application for Patent claims priority to Provisional Application No. 61/321,132 entitled Apparatus and Method for Cognitive Pattern Recognition filed Apr. 6, 2010, and assigned to the assignee hereof and hereby expressly incorporated by reference herein.

### FIELD

This disclosure relates generally to apparatus and methods for searching and visual presentation. More particularly, the disclosure relates to visual presentation of search results to assist cognitive pattern recognition.

### BACKGROUND

In current document files, it is known that many documents with similar or even identical words exist. Thus, with the commonality of words and phrases in different documents or even different versions of the documents, it is time consuming to find an exact document quickly and efficiently. Often, a keyword search could produce a list of many documents with the same word and even include all the various versions of the different documents containing the keyword. This is especially problematic if the keyword used in the search is a common word for a particular application.

### SUMMARY

Disclosed is an apparatus and method for. According to one aspect, a method for searching using cognitive pattern recognition comprising searching at least one document associated with a search text; presenting a quantity of the at least one document in a scaled common image format (CIF); selecting a document in the quantity for display; adding a visual distinction to all pages of the selected document where the search text exists from the rest of the pages of the selected document; and displaying all pages of the selected document wherein the search text exists in the scaled common image format (CIF).

According to another aspect, an apparatus for creating an association between a word and an object, the apparatus comprising a processor and a memory, the memory containing program code executable by the processor for performing the following: searching at least one document associated with a search text; presenting a quantity of the at least one document in a scaled common image format (CIF); selecting a document in the quantity for display; adding a visual distinction to all pages of the selected document where the search text exists from the rest of the pages of the selected document; and displaying all pages of the selected document wherein the search text exists in the scaled common image format (CIF).

According to another aspect, an apparatus for searching using cognitive pattern recognition comprising means for searching at least one document associated with a search text; means for presenting a quantity of the at least one document in a scaled common image format (CIF); means for selecting a document in the quantity for display; means for adding a visual distinction to all pages of the selected document where the search text exists from the rest of the pages of the selected document; and means for displaying all pages of the selected document wherein the search text exists in the scaled common image format (CIF).

According to another aspect, a computer-readable medium storing a computer program, wherein execution of the computer program is for searching at least one document associated with a search text; presenting a quantity of the at least one document in a scaled common image format (CIF); selecting a document in the quantity for display; adding a visual distinction to all pages of the selected document where the search text exists from the rest of the pages of the selected document; and displaying all pages of the selected document wherein the search text exists in the scaled common image format (CIF).

Advantages of the present disclosure may include reducing the steps and time needed to search for an object (e.g., a document) or information within the object. Another possible advantage includes increased accuracy and built in fault tolerance in locating an object or information within the object.

It is understood that other aspects will become readily apparent to those skilled in the art from the following detailed description, wherein it is shown and described various aspects by way of illustration. The drawings and detailed description arc to be regarded as illustrative in nature and not as restrictive.

### BRIEF DESCRIPTION OF THE DRAWINGS

FIG. 1 illustrates an example of a first flow diagram for visual presentation of search results to assist cognitive pattern recognition.

FIG. 2 illustrates an example of a second flow diagram for visual presentation of search results to assist cognitive pattern recognition.

FIG. 3a illustrates an example of a first visual distinction on pages of a selected document where the search text exists.

FIG. 3b illustrates an example of a second visual distinction on pages of a selected document where the search text exists.

FIG. 4a illustrates an example of a first visual distinction on pages of a selected document where the search text exists and the search text is presented in a different format than the rest of the text.

FIG. 4b illustrates an example of a second visual distinction on pages of a selected document where the search text exists and the search text is presented in a different format than the rest of the text.

FIG. 5 illustrates an example of a device comprising a processor in communication with a memory for executing the algorithms in the flow diagrams described in FIGS. 1 and/or 2.

FIG. 6 illustrates an example of a First device suitable for visual presentation of search results to assist cognitive pattern recognition in the flow diagram illustrated in FIG. 1.

FIG. 7 illustrates an example of a second device suitable for visual presentation of search results to assist cognitive pattern recognition in the flow diagram illustrated in FIG. 2.

### DETAILED DESCRIPTION

The detailed description set forth below in connection with the appended drawings is intended as a description of various aspects of the present disclosure and is not intended to represent the only aspects in which the present disclosure may he practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and arc not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively he represented as a series of interrelated states or events, such as in a state diagram. Moreover, not all illustrated acts may be required to implement a methodology in accordance with one or more aspects.

A search may be based on not just words contained in a document, but also the user's memory of a visual image of the document and/or the approximate date of the document. For example, different documents or versions of a same document may contain many identical keywords. However, the visual presentation of the first page of different document types may differ. Thus, there's a need for a search approach that can utilize the aspects of keyword searching and visual presentation of the document and/or the approximate date of the document being searched to quickly and efficiently locate the document in a document repository (e.g., database.). One skilled in the art would understand that a document repository may include an electronic repository or an electronic database.

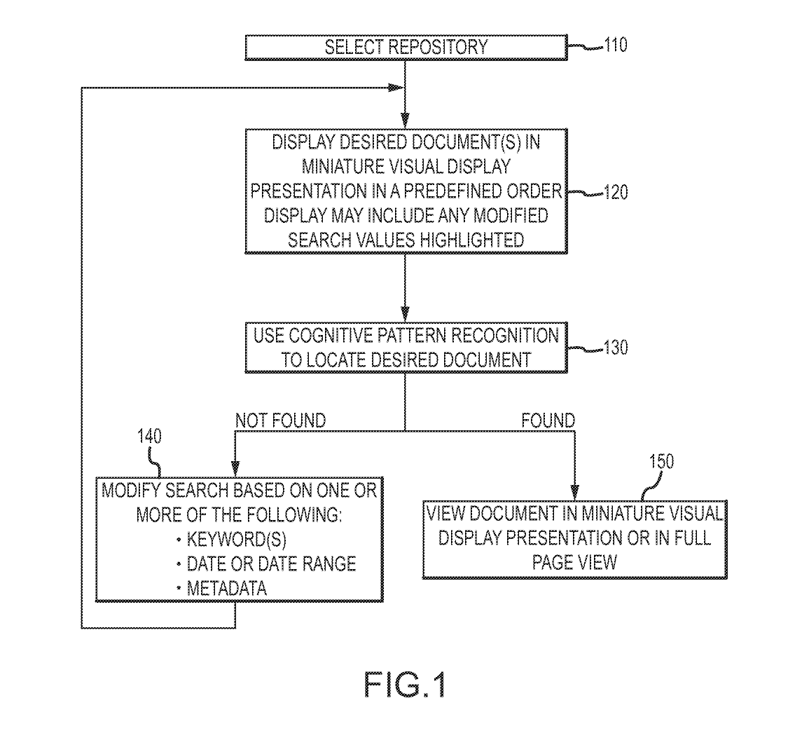

FIG. 1 illustrates an example of a first flow diagram for visual presentation of search results to assist cognitive pattern recognition. In block 110, select a repository. In one example, the repository is the Internet. In another example, the repository is a private database. In block 120, display desired documents in miniature visual display presentation in a predefined order. In one example, the display may include any modified search values highlighted. In block 130, use cognitive pattern recognition to locate desire document. If the desired document is not found, or there are numerous documents to review, proceed to block 140. In block 140, modify the search based on one or more of the following: keyword(s), date or date range, meta data, etc. If the desired document is found, proceed to block 150. In block 150, view the found document in miniature visual display presentation or in full page view.

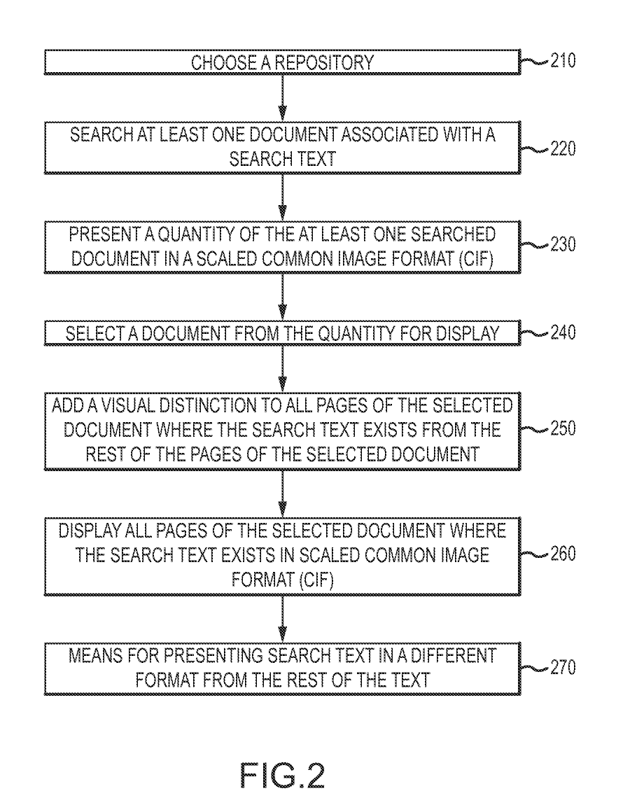

FIG. 2 illustrates an example of a second flow diagram for visual presentation of search results to assist cognitive pattern recognition. In block 210, choose a repository. In block 220, search for a document associated with a search text in the repository. In example, the search text is a single word. In another example, the search text comprises of multiple words. In yet another example, the search text is a phrase of contiguous words. In block 230, Present a quantity of the searched documents in a scaled common image format (CIF). In one example, the quantity is predefined. In one aspect, common image format is a digital representation of a document which retains the look and feel of the document in a printed form or it is a visual representation of the pages within digitally converted paper or electronically created documents. In one example, the first page of each of the quantity of the searched documents is presented in the scaled common image format (CIF). In one example, a first page of each of the quantity of the searched documents is presented in the scaled common image format (CIF). In one example, the presenting of the quantity is done in a predetermined order. And, in one example, the predetermined order is based on a meta data parameter. In one aspect, at least one metadata parameter is presented along with the scaled common image format (CIF). In another aspect, a portion of a meta-data parameter is presented along with the scaled common image format (CIF). In one example, the meta-data parameter is modified before being presented. In one aspect, the at least one meta-data parameter is a date information. The date information could, for example, be a date the document is created, a date contained within the document, a date the document is processed, such as scanned, or a date assigned to the document, etc.

In block 240, select one document in the quantity for display. One skilled in the art would understand that although block 240 defines selecting one document, that selecting multiple documents in the quantity for display is not prohibited and is also within the scope and spirit of the present disclosure. In block 250, add a visual distinction to all the pages of the selected document where the search text exists. The visual distinction allows a user to quickly distinguish the pages where the search text exists from the rest of the pages of the selected document where the search text does not exist. In block 260, display all the pages of the selected document where the search text exists in the scaled common image format. In one example, the display of all the pages is on at least one digital screen. One skilled in the art would understand that although the step in block 250 is written to precede the step in block 260, the order of the two steps may be interchanged without affecting the scope or spirit of the present disclosure. In block 270, present the search text in a different format from the rest of the text. In one example, the different format is one of the following: bolding, highlighting, italicizing, underlining, etc. In one example, the rest of the text is confined to the text on the same page that is not the search text. In another example, the rest of the text is confined to the text in the selected document that is not the search text. In one aspect, all occurrences of the search text is shown in the different format at the same time (e.g., simultaneously) on all the pages of the selected document where the search text exists. In one aspect, some of the steps in FIG. 2 are performed by a computer, such as a personal computer. In another aspect, some of the steps in FIG. 2 are performed by a handheld device that incorporates at least one processor.

In one example, although the step in block 270 is shown as the last step of the flow presented in FIG. 2, one skilled in the art would understand that the step of block 270 may take place elsewhere in the flow without affecting the scope or spirit of the present disclosure.

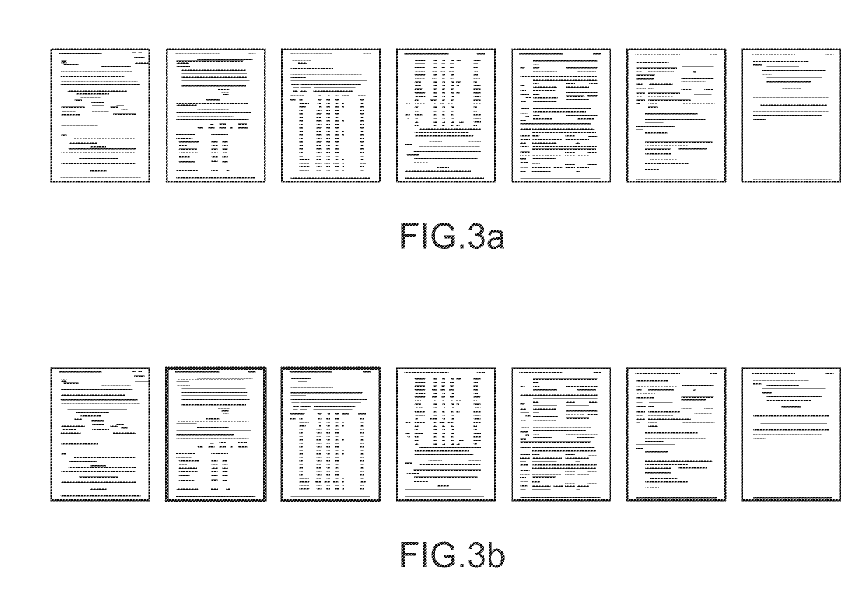

FIG. 3a illustrates an example of a first visual distinction on pages of the selected document where the search text exists. In this example, the first visual distinction is the added pace number on each page of the selected document where the search text exists. FIG. 3b illustrates an example of a second visual distinction on pages of a selected document where the search text exists. In this example, the second visual distinction is the added border on each page of the selected document where the search text exists.

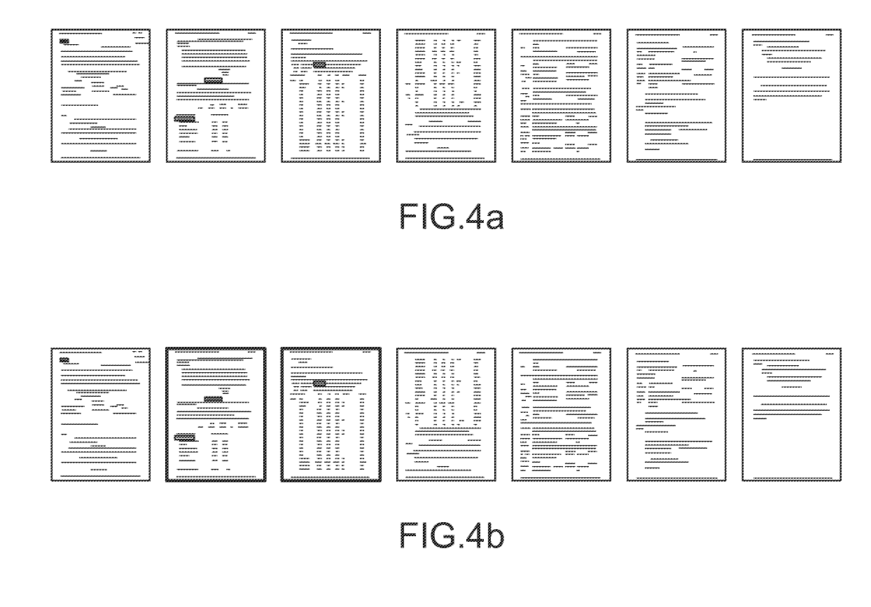

FIG. 4a illustrates an example of the first visual distinction on pages of the selected document where the search text exists and the search text is presented in a different format than the rest of the text. FIG. 4b illustrates an example of the second visual distinction on pages of a selected document where the search text exists and the search text is presented in a different format than the rest of the text. In the examples in FIGS. 4a and 4b, all occurrences of the search text is highlighted. However other forms of different formats, such as but not limited to, bolding, italicizing, underlining, etc. may be used without restricting the scope and spirit of the present disclosure.

In one example, printed documents are filed or stored. In another example the printed paper document is migrated into a digital file format. For example, a document may be a single page document or a “staple group” which may be a multi page document or a related group of documents grouped together (e.g., stapled or clipped together) and filed into a file folder, hinder, cabinet etc. In one aspect, the “staple group” is a group of pages, documents or files electronic linked together. A document may be digitally created and/or modified and stored electronically. A document may comprise, for example, a primary document and any electronic file attachments (e.g. file attachments within an email) including nested embedded documents (Excel spreadsheet inside a Power Point presentation). Each modified and stored instance of a digital file may be considered a unique document (e.g. different versions of a document, email threads etc).

In one aspect, cognitive pattern recognition is based on prior cognitive knowledge. For example, recognition is based on a collective memory about the document being searched. The cognition pattern being recognized may be based on memory of one or more of the following: file format (e.g., Word, Excel etc.), approximate date of the document (last month, last quarter, last year etc.), from and to details on correspondence/email/fax, keywords within documents, key sections within documents (e.g., pricing details within a proposal or termination clause within a contract); memory of how various digital file formats look.

In another example, recognition is based on cognitive intelligence. For example, the search is for a document that one is not familiar with, however aspects of the document are known to the searcher. In one example, the search is for a tax form, a court document or a lab report, etc, wherein each has its unique image pattern that is easily recognizable. In another example, the location of the search text (e.g., highlighted keyword(s)) within a page in common image format allows cognitive pattern recognition. Based on common image format (e.g., miniature visual display) of documents containing highlighted keyword(s), one can quickly recognize and comprehend the relevance of various documents like Correspondence, Presentations, Proposals Cost Estimates for Cleanup etc. as events on a time line or as a relevant document pertaining to an issue.

One skilled in the art would understand that the steps disclosed in the example flow diagrams in FIGS. 1 and 2 can be interchanged in their order without departing from the scope and spirit of the present disclosure. Also, one skilled in the art would understand that the steps illustrated in the flow diagrams are not exclusive and other steps may be included or one or more of the steps in the example flow diagrams may be deleted without affecting the scope and spirit of the present disclosure.

Those of skill would further appreciate that the various illustrative components, logical blocks, modules, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may he stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise memory stick, RAM, ROM, EEPROM, CD-ROM or other optical disk storage, magnetic disk storage or other magnetic storage devices, or any other medium that can he used to carry or store desired program code in the form of instructions or data structures and that can he accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair. DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

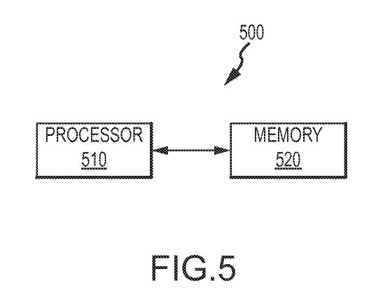

In one example, the illustrative components, flow diagrams, logical blocks, modules and/or algorithm steps described herein arc implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 5 illustrates an example of a device 500 comprising a processor 510 in communication with a memory 520 for executing the algorithms in the flow diagrams described in FIGS. 1 and/or 2. In one example, the device 500 is used to implement the algorithm illustrated in FIG. 1. In another example, the device 500 is used to implement the algorithm illustrated in FIG. 2. In one aspect, the memory 520 is located within the processor 510. In another aspect, the memory 520 is external to the processor 510. In one aspect, the processor includes circuitry for implementing or performing the various flow diagrams, logical blocks and/or modules described herein.

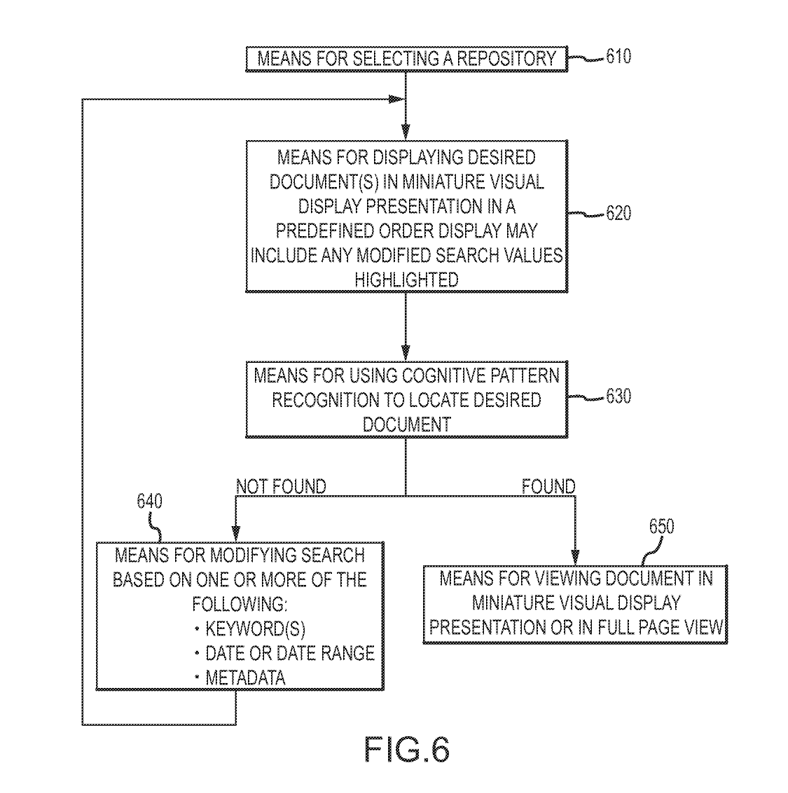

FIG. 6 illustrates an example of a device 600 (first device) suitable for visual presentation of search results to assist cognitive pattern recognition in the flow diagram illustrated in FIG. 1. In one aspect, the device 600 is implemented by at least one processor comprising one or more modules configured to search using cognitive pattern recognition as described herein in blocks 610, 620, 630, 640 and 650. For example, each module comprises hardware, firmware, software, or any combination thereof. In one aspect, the device 600 is also implemented by at least one memory in communication with the at least one processor.

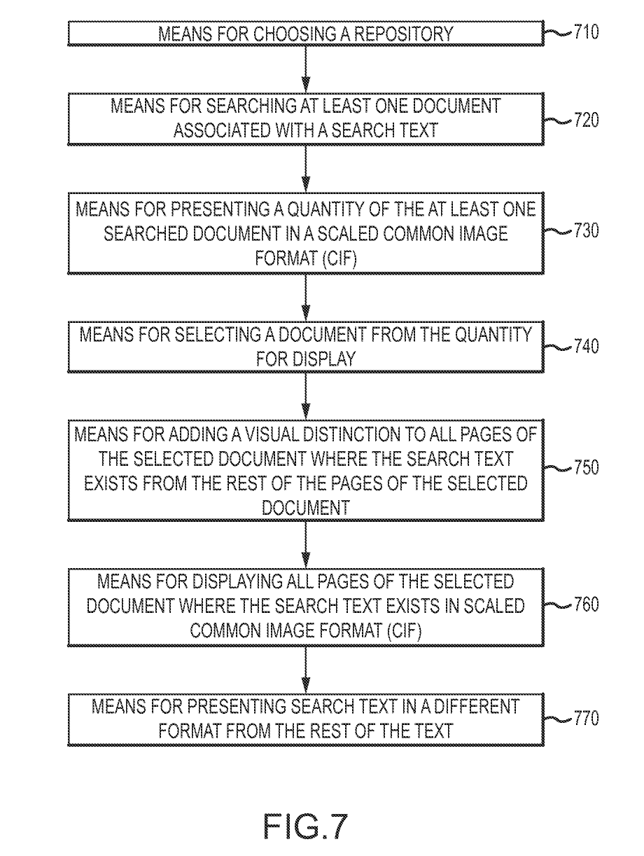

FIG. 7 illustrates an example of a device 700 (second device) suitable for visual presentation of search results to assist cognitive pattern recognition in the flow diagram illustrated in FIG. 2. In one aspect, the device 700 is implemented by at least one processor comprising one or more modules configured to search using cognitive pattern recognition as described herein in blocks 710, 720, 730, 740, 750, 760 and 770. For example, each module comprises hardware, firmware, software, or any combination thereof. In one aspect, the device 700 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for searching using cognitive pattern recognition comprising:
searching at least one document associated with a search text;
presenting a quantity of the at least one document in a scaled common image format (CIF);
selecting a document in the quantity for display;
adding a visual distinction to all pages of the selected document where the search text exists from the rest of the pages of the selected document; and
displaying all pages of the selected document wherein the search text exists in the scaled common image format (CIF).

2. The method of claim 1 wherein the search text is shown in a different format than the rest of the text.

3. The method of claim 2 wherein the search text is shown in the different format at the same time on all the pages of the selected document where the search text exists.

4. The method of claim 1 further comprising choosing a repository for searching.

5. The method of claim 1 wherein a first page of each of the quantity of the at least one document is presented in the scaled common image format (CIF).

6. The method of claim 1 further comprising presenting the quantity in a predetermined order.

7. The method of claim 6 wherein the predetermined order is based on a meta data parameter.

8. The method of claim 1 further comprising displaying at least one meta data parameter along with the scaled common image format (CIF) of the quantity of the at least one document.

9. An apparatus for creating an association between a word and an object, the apparatus comprising a processor and a memory, the memory containing program code executable by the processor for performing the following:
searching at least one document associated with a search text;
presenting a quantity of the at least one document in a scaled common image format (CIF);
selecting a document in the quantity for display;
adding a visual distinction to all pages of the selected document where the search text exists from the rest of the pages of the selected document; and
displaying all pages of the selected document wherein the search text exists in the scaled common image format (CIF).

10. The apparatus of claim 9 wherein the search text is shown in a different format than the rest of the text.

11. The apparatus of claim 10 wherein the search text is shown in the different format at the same time on all the pages of the selected document where the search text exists.

12. The apparatus of claim 9 wherein the memory further comprising program code for choosing a repository for searching.

13. The apparatus of claim 9 wherein a first page of each of the quantity of the at least one document is presented in the scaled common image format (CIF).

14. The apparatus of claim 9 wherein the memory further comprising program code for presenting the quantity in a predetermined order.

15. The apparatus of claim 14 wherein the predetermined order is based on a meta data parameter.

16. The apparatus of claim 9 wherein the memory further comprising program code for displaying at least one meta data parameter along with the scaled common image format (CIF) of the quantity of the at least one document.

17. An apparatus for searching using cognitive pattern recognition comprising:
means for searching at least one document associated with a search text;
means for presenting a quantity of the at least one document in a scaled common image format (CIF);
means for selecting a document in the quantity for display;
means for adding a visual distinction to all pages of the selected document where the search text exists from the rest of the pages of the selected document; and
means for displaying all pages of the selected document wherein the search text exists in the scaled common image format (CIF).

18. The apparatus of claim 17 wherein the search text is shown in a different format than the rest of the text.

19. The apparatus of claim 18 wherein the search text is shown in the different format at the same time on all the pages of the selected document where the search text exists.

20. The apparatus of claim 17 further comprising means for choosing a repository for searching.

21. The apparatus of claim 17 wherein a first page of each of the quantity of the at least one document is presented in the scaled common image format (CIF).

22. The apparatus of claim 17 further comprising presenting the quantity in a predetermined order.

23. The apparatus of claim 22 wherein the predetermined order is based on a meta data parameter.

24. The apparatus of claim 17 further comprising means for displaying at least one meta data parameter along with the scaled common image format (CIF) of the quantity of the at least one document.

25. A computer-readable medium storing a computer program, wherein execution of the computer program is for:
searching at least one document associated with a search text;
presenting a quantity of the at least one document in a scaled common image format (CIF);
selecting a document in the quantity for display;
adding a visual distinction to all pages of the selected document where the search text exists from the rest of the pages of the selected document; and
displaying all pages of the selected document wherein the search text exists in the scaled common image format (CIF).

26. The computer-readable medium of claim 25 wherein the search text is shown in a different format than the rest of the text.

27. The computer-readable medium of claim 26 wherein the search text is shown in the different format at the same time on all the pages of the selected document where the search text exists.

28. The computer-readable medium of claim 25 wherein execution of the computer program is also for choosing a repository for searching.

29. The computer-readable medium of claim 25 wherein a first page of each of the quantity of the at least one document is presented in the scaled common image format (CIF).

30. The computer-readable medium of claim 25 wherein execution of the computer program is also for presenting the quantity in a predetermined order.

31. The computer-readable medium of claim 30 wherein the predetermined order is based on a meta data parameter.

32. The computer-readable medium of claim 25 wherein execution of the computer program is also for displaying at least one meta data parameter along with the scaled common image format (CIF) of the quantity of the at least one document.

33. A method for searching using cognitive pattern recognition comprising:
searching at least one document associated with a search text;
presenting a quantity of the at least one document in a scaled common image format (CIF) image in date order, wherein each CIF image shows the search text in a different format;
presenting meta data associated with each of the at least one document with the search text in the different format in the meta data;
selecting for display a document in the quantity;
adding a visual distinction to all pages of the selected document where the search text exists from the remaining pages of the selected document; and
displaying all pages of the selected document wherein the search text exists in the scaled common image format (CIF).

34. The method of claim 33 further comprising presenting the CIF image with the number of pages of the at least one document associated with the CIF image.

35. The method of claim 33 further comprising presenting the first page of each of the at least one document.

36. The method of claim 33 wherein the different format is one of the following:
bolding, highlighting, italicizing or underlining.
